(19) United States
(12) Patent Application Publication
(10) Pub. No.: US 2005/0053205 A1
(43) Pub. Date: Mar. 10, 2005

(54) Message delivery and acquisition system

(76) Inventor: Jeffrey C Hays, Sandy, UT (US)

Correspondence Address: LLOYD W. SADLER;MCCARTHY & SADLER, LC, 39 EXCHANGE PLACE, SUITE 100, SALT LAKE CITY, UT, 84111, US

(21) Appl. No.: 10/507,155

(22) PCT Filed: Mar. 7, 2003
(86) PCT No.: PCT/US03/07077

Related U.S. Application Data
(60) Provisional application No. 60/362,491, filed on Mar. 7, 2002.

(51) Int. Cl. H04M 1/64; H04M 11/00

(52) U.S. Cl. 379/88.19; 379/88.16; 379/67.1

(57) ABSTRACT

A method (FIG. 1) for utilizing a voice-command based network platform to record and deliver outbound voice messages, and request and deliver a voice-recorded response back to the sender at the urgency and location requested by the sender. This is accomplished by using voice recognition, telephone keypad, or GUI to identify recipients, specify the time, date, frequency and duration of delivery attempts, and interface with recipient to secure a response.

### BACKGROUND OF THE INVENTION

1. Field of the Invention

This invention relates to telephone communications systems. More specifically, this invention relates to automated message delivery and collection telephone communications systems.

2. Description of Related Art

A variety of methods and systems have been proposed for the distribution of automated telephone messages. Generally, however such systems fail to provide voice message collection in response to the automated messages. Also, such systems typically do not include voice recognition functions that would permit the user's convenient interaction with the system and that would permit an e-mail confirmation of a message or response.

### SUMMARY OF THE INVENTIONS

It is desirable to provide a system and method that enables a user to direct specific messages to specific recipients and which collects responsive voice messages from the recipients, all through a standard telephone connection. It is also desirable to provide a systems and method that takes oral instructions from the user as to who the user would like to call, when the user would like the call to be made and what message is to be delivered to the user.

Accordingly, it is an object of this invention to provide a system and method for the distribution of oral messages and the collection of oral responses.

An additional object of this invention is to provide a system and method for the distribution of oral messages which provide voice recognition capabilities for the direction of the message delivery.

A further object of this invention is to provide a system and method for the distribution of oral messages and the collection of oral responses that permits the user to specify the recipient, the message and the time of delivery for messages.

A still further object of some embodiments of this invention is to provide a system and method for the digital collection and reporting of messages and/or responses.

It is another object of this invention to provide a system and method for the distribution of oral messages and the collection of oral responses that is compatible with standard telephone equipment and which can be accessed at remote locations.

Additional objects, advantages and other novel features of this invention will be set forth in part in the description that follows and in part will become apparent to those skilled in the art upon examination of the following or may be learned with the practice of the invention. The objects and advantages of this invention may be realized and attained by means of the instrumentalities and combinations particularly pointed out in the appended claims. Still other objects of the present invention will become readily apparent to those skilled in the art from the following description and drawings, wherein there is shown a present preferred embodiment of the invention, simply by way of illustration of one of the modes best suited to carry out this invention. As it will be realized, this invention is capable of other different embodiments, and its several details and specific steps are capable of modification in various aspects without departing from the concept of this invention. Accordingly, these objects, the description and drawings should be regarded as illustrative in nature and not as restrictive.

### BRIEF DESCRIPTION OF THE DRAWINGS

The accompanying drawings incorporated in and forming a part of the specification, illustrate a present preferred embodiment of this invention. Some, although not all, alternative embodiments are described in the following description.

In the drawings:

FIG. 1 is a detailed flow chart of the system entrance section.

FIG. 2 is a detailed flow chart of the registration section.

FIG. 3 is a detailed flow chart of the get password section.

FIG. 4 is a detailed flow chart of the remember password section.

FIG. 5 is a detailed flow chart of the zing back section.

FIG. 6 is a detailed flow chart of the scenario 1 section.

FIG. 7 is a detailed flow chart of the optional scenario 2 section.

FIG. 8 is a detailed flow chart of the help section.

FIG. 9 is a detailed flow chart of the add a contact section.

FIG. 10 is a detailed flow chart of the add a phone number section.

FIG. 11 is a detailed flow chart of the additional recipients section.

FIG. 12 is a detailed flow chart of the record a zing message section.

FIG. 13 is a detailed flow chart of the send a zing options section.

FIG. 14 is a detailed flow chart of the send a zing message section.

FIG. 15 is a detailed flow chart of the receive a zing section.

FIG. 16 is a detailed flow chart of the after zing play section.

FIG. 17 is a detailed flow chart of the viral piece section.

FIG. 18 is a detailed flow chart of the rescheduled zing section.

FIG. 19 is a detailed flow chart of the review zings section.

FIG. 20 is a detailed flow chart of the review zing backs section.

FIG. 21 is a detailed flow chart of the after zing review section.

FIG. 22 is a detailed flow chart of the add+location+name section.

FIG. 23 is a detailed flow chart of the alternative scenario 2 section.

FIG. 24 is a detailed flow chart of the change+location+name section.

FIG. 25 is a top-level flow chart of the method of this invention.

Reference will now be made in detail to the present embodiments of the invention, examples of which are illustrated in the accompanying drawings.

### DETAILED DESCRIPTION OF THE INVENTION

This invention is a method and system for directing a user's messages to recipients and for receiving responsive messages from such recipients on a remote bases. A user of the system typically connects to the system through a telephone connection, such as by calling a telephone number. The system then takes oral instructions from the user as to who the user would like to call and when. This information can be prompted by the system by voice prompts so, for example, when the user calls in to the system, after user identification, the system may ask: “Who would you like to call?” The user then speaks and tells the system who he or she would like to call. The system then either recognizes the name from information previously entered into the system and knows the telephone number or, if the system does not already have the telephone number, asks the user for the telephone number. The system can then ask when the message should be forwarded. the system uses voice recognition functions to understand the voice information received from the user and/or the recipient. The system records the message to be delivered. The system may then ask if another message is to be delivered, and if yes, proceeds as described above to obtain the information and message to be delivered for the next message. This process continues until all directions are obtained for all messages to be recorded for later delivery by the system.

The system then delivers the messages as instructed and gives the person called (hereinafter the “recipient”) an opportunity to respond. Thus, if the user (or caller) has recorded a message to be delivered to a particular person at 9:00 a.m. on a particular day, the system dials the desired recipient's telephone number at the indicated delivery time and, when the person answers, announces that it has a message for the particular person specified. If the person, now recipient, indicates that he or she will accept the message, the system plays the recorded message to the recipient and asks if that person wishes to leave a response. If yes, the system records the recipient's response and holds it for retrieval by the user, or otherwise delivers the recorded response to the user, such as by calling the user.

In its present embodiment, this invention allows a subscriber to create and send voice messages from any telephone to a recipient via any defined phone numbers in real time or at a specified time. The invention prompts the recipient to record a message to be delivered back to the user (subscriber) at a specified location.

Subscribers can currently set up and manage their Contacts in one of three ways. (1) Transfer information from Outlook or Netscape address books to their Contacts directory. All directory information from these sources is read by the process of this invention and is accessible to the subscriber via telephone and/or Internet interfaces. (2) Manually keyboard Contact information using the provided graphical user interface (GUI). (3) Input Contact information “on the fly” using the telephone keypad and/or voice commands. When a subscriber enters a number that is unrecognized by the system, the process automatically asks for a name to associate with the number and stores it in the subscriber's Contacts.

Subscribers can manage their Contact information and create or edit their personal settings using the GUI on the system web site. A limited number of features and also be modified through the Telephone User Interface (TUI).

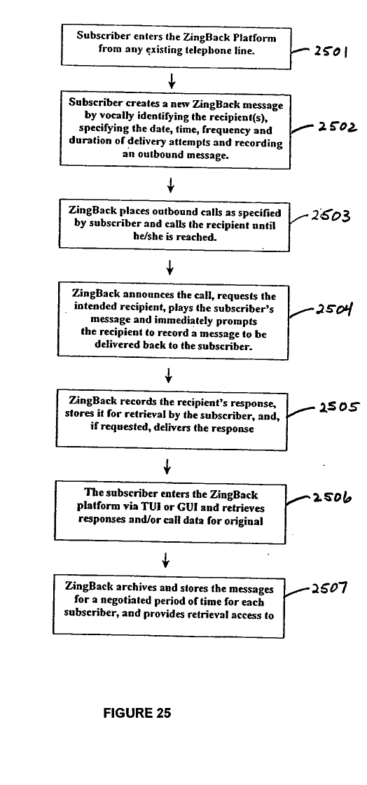

Referring to FIG. 25, to utilize the service, subscribers enter 2501 the system platform, typically via a central toll-free number and are authenticated by a 4 to 10 digit PIN or through an individual toll-free number assigned to that unique user. An individual password is optional. Upon entering the system platform, the subscriber can: (1) create a new ZingBack message; (2) add new contacts; (3) review or cancel ZingBack messages which have not yet been sent; and (4) listen to their ZingBack responses to messages.

ZingBack messages can be sent to one individual or a group of individuals as specified by the subscriber. Groups or Distribution lists can be set up and identified using the GUI, or can be specified by voice command while creating a new ZingBack message.

The subscriber creates 2502 a new ZingBack message by identifying the recipient(s), specifying the date, time, frequency and duration of delivery attempts and recording an outbound message. In the present embodiment, subscribers can schedule messages to be sent immediately or anytime up to seven days past the current date.

Once a subscriber creates 2502 a new ZingBack message and specifies when it is to be sent, ZingBack stores the information and attempts to deliver 2503 the message according to the subscriber's specifications. When delivering a message, the system will dial the recipient's number(s) and announce 2504 that they have a ZingBack message for “intended recipient.” The system will then offer four choices: (1) accept the ZingBack message; (2) hold while the recipient is located; (3) reschedule the call to be redelivered in 15, 30 or 60 minutes; or (4) decline the call at that location, and bounce to another number location.

Once accepted by the recipient, the message is played over the phone. When the recipient has listened to the message, he or she will be prompted to record a response to be delivered to the sender. The recipient will also be given the option to: (1) replay the message; or (2) pause the system while they retrieve information.

The received message is presently only accessible to the recipient within the session that the message was accepted.

ZingBack records 2505 the recipient's response, stores it for retrieval by the subscriber, and if requested, delivers the response immediately to the location specified by the subscriber. When the subscriber reenters the ZingBack platform via a TUI or a GUI, he or she can retrieve 2506 responses and/or call data for original messages. Presently, replies are delivered to the sender as a .wav file and are deposited in their ZingBox.

Because the messages are digitally recorded and stored, they are easily archived 2507 for retrieval, audit or verification at a later data. A subscriber can access any ZingBack messages that they have sent out, and any replies that were recorded utilizing the ZingBack GUI. These messages will be stored for a negotiated period of time and be downloaded to the subscriber's e-mail at specified intervals.

At present the method of the ZingBack system operates as software running on a ViPrNet software platform. ViPrNeT is a carrier-class distributed service platform, capable of scaling to millions of user volumes. It is based on an open architecture that separates transport, control and services, providing a very flexible common services platform. It is compatible with both circuit-based and packet-based networks, providing high availability and resource load balancing. It is integrated with XML common resource interface and is extremely scalable.

The following are the detailed rules and implementation details of the present embodiment of the invention.

ZINGBACK
Zing Back—Initial Call Flow ***DRAFT*** Version 1.0
Global Rules
Error handling
Silence, invalid, validate Rules global except where overridden in call flow
a. First occurrence:
b. Validation—Repeat Response
c. Invalid—Repeat Prompt
d. Silence—Repeat Prompt
e. Y/N Validation—Repeat Prompt C Second occurrence:
g. Validation—Bring to Help prompt repeating options
h. Invalid—Bring to Help prompt repeating options
i. Silence—Bring to I help prompt repeating options
j. Y/N Validation—Bring to I-tell) prompt repeating options
k. Third occurrence:
l. Validation—Help or hang-up—if help goto F
m. Invalid—Help or hang-up—if help goto F
n. Silence—Bring to Help or hang-up—if help goto F
o. Y/N Validation—Help or hang-up—if help goto F
Global commands
Help is specific to each menu—repeats valid options Goto Sleep Pauses system—3 min timeout wake up Wake up—wakes system up
Ledged for Call flow design
Red—refer to different call flow
_=Action
Bold=grammar
Call Flow #1—Main Menu
Main Menu:
Welcome to Zingback<
You have # new messages and # saved messages
To listen to replied messages say replied messages (2)_replied
<Prompt is not played if you have zero messages. If valid command is entered—then play prompt: you have no confirmation messages—goto main menu (prompt is not played if you have zero messages)
To send a zing say Zing (2) w′˜Send a Zing
For More Options say more options (3), More Options
Call Flow # 2—Replied to Messages
Replied Messages
You have (#) new messages, You have (#) saved messaged <(If no new—first prompt not played or if no saved second prompt is not played><(FIFO urgent><FIFO new><FFO saved>
The following message(s) are Urgent or new or saved
1) System plays envelope information
Message from (sender name sent at (time) on (date) System plays recorded message
2) End of message,
To replay this message say replay message (1)_Replay Message <When finished playing, go back to 2>
To save it says save (9) Save Message
To delete it say delete (7).—Delete Message For more options say options (3)
To reply to sender say reply to sender (S)×Recording and Send Zing (no need to add in contact info on send zing)
To go to the next message say next message (#).—Next Message TO return to the main menu say main menu (00)r˜Go to Main Menu Standard VM Options
Global error handling applies for all invalid, silence and validation scenarios>(Go back to 1 for the number of new messages until completed—
If applicable go back to 1 for the number of saved messages until c0mpletedWhen finished-go to main menu—
Call Flow # 3—Recording and sending Zings
Record a Zing (Order # I may change I) Play prompt:
“Record your Zing Message at the tone. pound.—tone>
2) Record message, until they stay silent or press 3) Play prompts:
To send your message say send it (1)_{—}
To listen to your recording, say listen to it (2) 1s Play message they recorded back to them, then repeat step 3)
TO re-record your message, say re-record it (3)_Go to step 2)
When you are finished recording, stay silent or press pound.
Send Zing Options reqs.
Recipients
First Additional Contact Prompt—Please say contact name, when done adding names say finished All Other Additional Contacts Prompt—Please say contact name
A. Subscriber says contact name
(system restates contact name) correct?
<Forced validation waiting for Y/N response>(do not allow two validations if reco issue) If subscriber response is yes next name
   Contact is added to list of recipients>If subscriber response is no˜; Go To 1 What number would you like to send this to Home I
Business I etc (dynamic list based on data entered)
Please say your next contact name or number or say finished Next name.! goto A.
If subscriber response is finished—, Go To Record Zing If subscriber response is stop/cancel
Do you want to cancel this Zing
   forced validation waiting for Y/N response>(do not allow two validations if reco issue) If subscriber response is yes Go To Main Menu
If subscriber response is no,˜Go To I
   global error handling applies for all invalid, silence and validation scenarios>
Send Zing Time Options reqs (Order 3—mange):
1) Play prompt: “When would you like to send this Zing Message?”
2) Reco a date using options like:
   a) asap, today, tomorrow, Monday, Tuesday, etc. . . . b) January 26″, February 14′ etc. . .
3) After getting valid date, repeat the date and
4) Play prompt: “At approximately what time would you like this zing message sent?”
5) RCCO a time using options like:
   a) 4 pm, 4 o'clock, noon, live-thirty, etc. . . 6) Schedule the zing to go out at the given time.
Call Flow #4—More Options from main Menu
To Manage Contacts say contacts (1) 0.4% Contacts Management To listen to confirmations say confirmations (2) f-<confirmations To listen to pending active zings say pending zings (3)_pending zings To customize preferences say preferences (4) re, Preferences
For system help say (5) Single system help prompt
Call Flow # 5—Managing Contacts
To add a contact say add contact (1)Add a Contact
To Delete a contact say delete contact (2) A—delete contact To edit a contact say edit contact (3); edit contact
Add A Contact:
1) Play prompt: “Say the name of the person you would like to add. Stay silent or say finished when done adding contacts.
a. Silent or finished.—goto managing contacts
b. Name entered x, Record their Contact and store in contact book.
2) Play prompt: “To Validate this contact say the name again [BEEP] (2 sec)”
a. If necessary, Play prompt: “You will need to say the name one more time
3) Play the name that was recorded for the user in wav format
4) Compare and check contacts for duplicate record
a. If exists, play prompt: “This person already exists in your contact book”_Managing contacts
b. If contact does not exist; Add a phone number
Add A Phone Number:
1) Play Prompt: “Say or enter the 10-digit phone number you would like to add for this contact, stay silent or say finished
a. Silent or finished˜? do not save name and goto managing contacts
b. N umber added—Record number and store it
2)
Validate the Number
Play prompt: “You entered (10-digit number system captured). Is this correct?” i.
   If no .% goto step I
ii. If yes
A) Play prompt:”
If this is a home number say home (1)
If this is a business number say business (2) If this is a mobile number say mobile (3)
If this is another number say other (4)
Home (1)_Validate with prompt “Do you want (user selection)?” if no play prompt ‘Please try again.’Repeat step 2A. If yes goto step 3
Business (2) i<Validate with prompt “Do you want (user selection)’?” If no k<play prompt ‘Please try again.’ Repeat step 2A
If yes goto step 3
Mobile (3);,—Validate with prompt “Do you want (user selection)’?” If no e<play prompt ‘Please try again.’ Repeat step 2A.
If yes goto step 3
Other (4) d Validate with prompt “Do you want (user selection)’?”
if no˜—play prompt ‘Please try again.’ Repeat step
2A. If yes goto step 3
3) Check for duplicate record
a. If there is a duplicate˜—, play prompt: “You have already added a (number type) number. Would you like to replace it’.”
iii. If yes play prompt: “Replaced.”˜−1 Play prompt: “Would you like to add another number?”
1. I f no r goto add contact
2. I f yes—start over in Add a phone number
iv. If no—play prompt: “Please try again,”—Repeat step 3a.
13. If there is not a duplicate r>play prompt: “(Contact name) (Number type) added.”
v. When numbers=4.<play prompt: “You have added the maximum numbers for this contact. To add additional numbers for this contact you will need to delete or change one of the current phone numbers.”
vi. When numbers <4 (,<Play prompt: “Would you like to add another number?”
I. If no (and it originated from add a contact),,<play prompt: “Would you like to add another contact?”
a. If no ;—,<Zing Main Menu
b. If yes e—’, Add a Contact
II. ‘yes—start over in Acid a phone number
Delete a contact
I) Say the name of the person you wish to delete a. Validate
Y (Icicle N, goto I
Edit A Contact:
1) Play prompt: “Say the name of the person you would like to edit. Stay silent or press # say when (lone.
Name entered .˜, goto 2.
2) Play the name that was recorded for the user in wav format
If you want to edit the name say edit name (1)_edit name
If you want to edit the phone number(s) say edit phone number(s) (2)˜—edit number Edit name
Please say the new Maine you would like for this contact Validate
When complete goto edit contact
Edit number
1) Play Prompt: “Say or enter the 10-digit phone number you would like to add for this contact, stay silent or say finished
Silent or finished e do not save name and goto managing contacts Number added Record number and store it
2) Validate the Number
Play prompt: “You entered (Ill—digit number system captured). Is this correct?” If no._goto step I
If yes
A). Play prompt:.
If this is a home number say home (1)
If this is a business number say business (2) If this is a mobile number say mobile (3) If this is another number say other (4)
Home (I) e Validate with prompt “Do you want (user selection)’.” If no ₛ% play prompt ‘Please try again.’ Repeat step 2A If yes_goto step 3)
Business (2)_Validate with prompt “Do you want (user selection)?” If no_play prompt ‘Please try again.’ Repeat step 2A.
If yes—goto step 3)
Mobile (3) s Validate with prompt “Do you want (user selection)’?”
If no .NS play prompt ‘Please try again.’Repeat step 2A. If yes_goto step 3)
Other (4) Validate with prompt “Do you want (user selection)’?”
If no_play prompt ‘Please try again.’Repeat step 2A If yes s_—s goto step 3)
3) Check for duplicate record
a. II′ dup˜play prompt: “You have already added a (number type) number.
   Would you like to replace it’?”
I. If yes play prompt: “Replaced.” d Play prompt: “Would you like 10 add another number’.)”
a. If yes->goto step b below
b. If no-, goto edit contact
b. Play prompt: “(Contact name) (Number type) added.”
i. When numbers=4′_s play prompt: “You have added the maximum numbers for this contact. To add additional numbers for this contact you will need to delete or change one of the current phone (lumbers.”
ii. When numbers <4 j-′ play prompt: “Would you like to add another number’?”
I. if no (and it originated from add a contact) play prompt: “Would you like to add another contact?”
a. If no y% Zing Main Menu
b. If yes s! Add a Contact
If yes x start over in Add a phone number
Call flow # 6
Confirmation Messages You have X new (Messages, You have x saved messaged
<If no new—first prompt not played or if no saved second prompt is not played><(FIFO urgent><I•IFO new><FIFO saved>
The following message(s) are Urgent or new or saved 1) System plays recorded message. When finished <Standard recording>
Your Zing sent at xx:xx on mm/dd/yy was sent to 7 people and failed to reach 3 of them. say resend failures (1) s re-Send zing (New) delete (7)
more options (0) (standard VM after playback options but need to include option for finding out who did not receive it and option to hear your original zing. This will then allow you to rezing to new people)
<goback to I for the number of message until completed-then goto new then saved if applicable 3) when finished—goto main menu>
Call Flow # 7—Pending Active Zings YOU have x pending zings.
<if no new—first prompt not played or if no saved second prompt is not played><I” I 10 new>
1) system plays recorded message. When finished <Standard recording>
Your Zing sent at xx:xx on 1 nm/dd/yy is schedule to goto # people at xx:xx on mm/dd/yy
To take no action and leave Zing Scheduled as planed say next message (#) Go to next pending message repeat step I
If no more messages back to _Main menu more Options Menu To edit the Zing message say edit zing message (I) goto call flow #3
To edit the Zing scheduled time say edit scheduled time (2) goto call flow # 3 To edit the Zing Recipients say edit names (3)_goto call flow #3
Cancel this Zing say cancel zing (7)
Silence: goes to next message repeat step I
If no messages˜—goes to Main menu/More options menu
Call Flow # R—Customize Preferences
I o receive/not receive confirmation messages say receive/don't receive confirmations (I)
Toggle>Default the
To receive/not receive pending Zing messages say receive/don't receive pending zings
(2)<Toggle>Default tad
To goto your account say my account (3) r′, T13D
To change your password say change password (4)
(Change Password
I) Please enter your original password validate
2) Please enter your new password
3) Please enter your new password again Match validate
No match your new passwords did not match try again goto 2
Call flow # 9—Overall System Help
Zing Help:
I) Play Prompt: “TBD” 2)
a. Examples
b. Sending; a Zing “To send a Zing message to one of your contacts you can say, for example, ‘Zing John Smith at home.’ OR say ‘zing’ and then a 10-digit number. c.

Adding a contact “You can say ‘add a contact’ after the ready tone to add contact over the phone. OR You can add contacts from our website at www.zingback.com’
d. Reviewing Zings “You can say ‘review Zings’ by date and time. . . ”
e. Reviewing Zing Backs “You can say ‘review Zing Backs’ 1?v date and time . . . ”
f. The following global commands are always available
Goto sleep—(systems pauses until you speak again for 3 min) Help—system offers help specific to the menu you are in Etc,.
Call Flow #10
Receive Zing
Call Detection scenarios to be discussed with technical team
Recipient phone number is answered
I) This is a Zing message for (contact name) from (subscriber name), if you are not (contact name) please press 1 or say 1 am not (contact name)
If silence or anything invalid y! play message
Standard VM during playback options
After playback record your reply at the tone f′˜ goto record Zing (no need to use schedule or contacts)
If response with I or they arc not contact
To Transfer this message to (contact) say transfer (I) z System wait to detect connection then goto step I
To put this system on hold while you locate (contact) say (2)′-s Please say wake up or press any digit when you ready to continue
To reschedule delivery of this message say reschedule (3) v_{—}5 goto schedule zing flow To Decline this message say decline (4) z Thank you
Initial Product Functionality
Subscriber TUI
   Subscriber Access
   Subscriber Personal Toll-Free Number
   Central Toll-Free Number
   Zing Box Functionality o Contacts
   Add And Edit Contacts On The Fly
   Domestic, International And Toll-Free Number Destinations
   Create and Send Messages
   Address To Single or Multiple Recipients
   Address To Groups
   Address To 10 Digit Numbers
   Review, Cancel and Re-Record Outgoing Message
   Flag Urgent
   Global Setting Per Subscriber Defined On GUI Future Delivery
   One Week Window
   Go To Sleep Function (Pause System)
   Reviewing Zing Messages
   Zing Back Messages
   Replies From Recipient
   Play/Replay Message (Current Status, Alt Headers & Bodies)
   Reply To Sender (New Coments, All Headers & Bodies)
   Skip/Delete Message
   Undelivered Message Notification
   Play/Replay Message (Status, Header & Body)
   Resend Message (Original Body & Recipient)
   Skip/Delete Message
   Declined By Recipient Notification
   Play I Replay Message (Status, Header & Body)
   Resend Message (Original Body & Recipient)
   Skip/Delete Message Delivered Zing Messages
   Play/Replay Message (Status, Header & Body)
   Resend Message (Original Body & Recipient)
   Skip & Delete Message
talk
ZingBack Product Overview
Subscriber GUI
   Initial New Subscriber Enrollment
   Secure Credit Card Capture
   Contacts
   Review
   Add
   Individual & Group
   Edit
   Delete
   Inbox
   Message Functionality
   Sorting Capability
   Play Message
   Delete Message
   Resend & Cancel (as defined under TUI Inbox Message Types)
   Message Types
   Replies From Recipient
   Undelivered Message Notification
   Resend Message
   Declined By Recipient Notification
   Resend Message
   Pending Messages (Message not yet delivered)
   Cancel Delivery (All recipients only)
   Personal Settings
   Remember Password Toggle
   Zing Urgent (total delivery attempts at what frequency)
   Global Setting Per Subscriber
      Recipient TUI
   Message Delivery Functionality o Accept
   Play
   Replay
   Pause Message
   Reply To Sender
   Hold
   Receptionist Screening o Reschedule
   Postpone Delivery for 15, 30 or 60 Minutes
   Decline At This Destination
   Bounce Call to Next Destination, if One Exists
   If One Doesn't Exist, Treat Call as Declined By Recipient
   Viral Marketing
   Integrated in Recipient TUI Call Flow

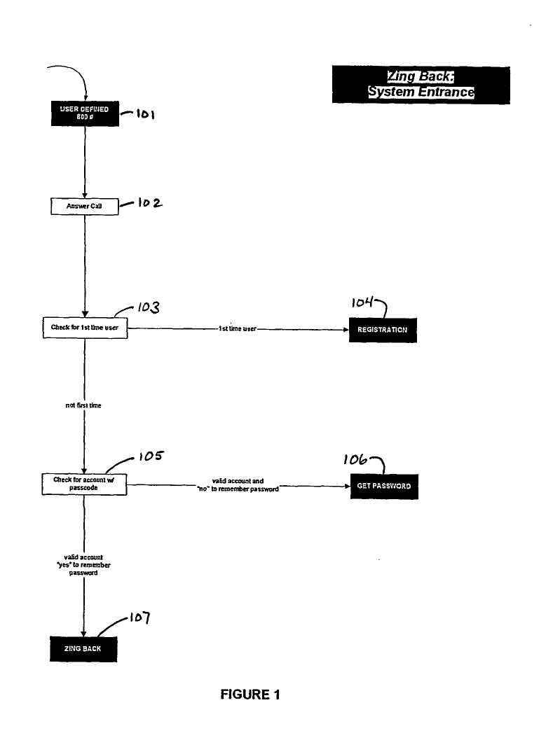

FIG. 1 shows a detailed flow chart of the system entrance section. The user dials in 101, typically through an 1-800 number. The call is answered 102. A check 103 is made to determine if the user is a first time user. If it is a first time user, the process goes to Registration 104. If it is not a first time user, then a check 105 is made for an account and passcode. If there is a valid account, but no passcode then the process goes to Get Password 106. If there is a valid account and passcode is remembered then the process proceeds to ZingBack 107.

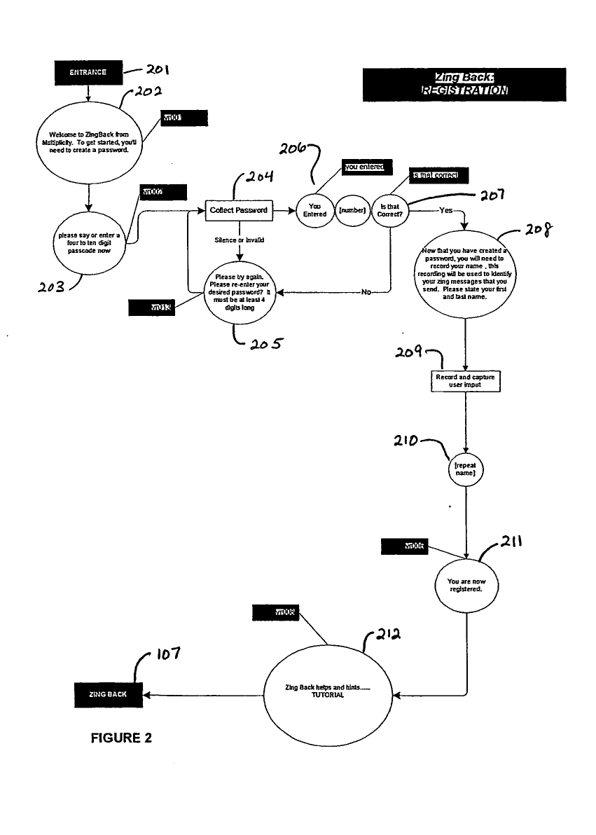

FIG. 2 shows a detailed flow chart of the registration 104 section. The user enters 201. The user is welcomed 202 to ZingBack and is ask 203 to enter a four to ten digit passcode. The passcode is collected 204 from the user. If a passcode is not detectable the user is asked 205 to try again. If the passcode is collected it is confirmed 206 and the user is asked 207 if it is correct. If not correct, the user is asked 205 to try again. If it is correct the user is asked 208 to record his or her name. The name is recorded 209. The name is repeated 210. The user is informed 211 that he or she is now registered. A tutorial is offered 212. The process proceeds to ZingBack 107.

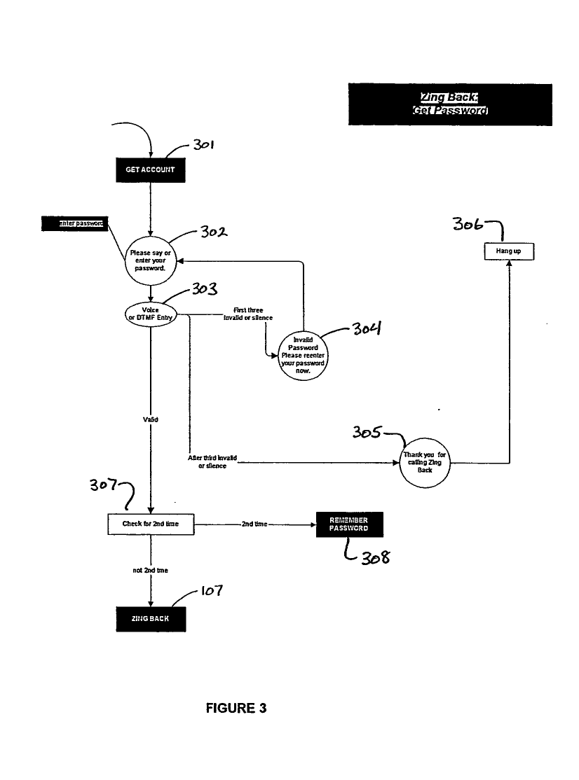

FIG. 3 shows a detailed flow chart of the get password 106 section. The account is gotten 301. The user is asked 302 to enter his or her password. A determination 303 is made if the entry was valid. If not, for the first three tries, the user is asked 304 to reenter the password. After the first three tries, the user is thanked 305 and the system hangs-up 306. If the password entry is valid, a confirmation check is made 307, if the password has been checked for a second time it is remembered 308. If not, the process goes to ZingBack 107.

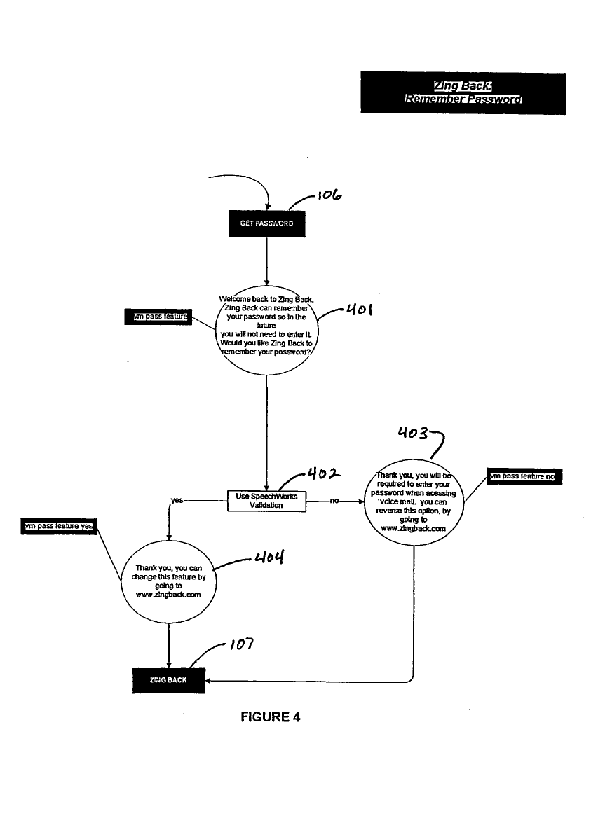

FIG. 4 shows a detailed flow chart of the remember password 308 section. After the Get Password 106 section, the user is invited 401 to allow the ZingBack system to remember the password. If 402 the user wishes the system to remember the password, then the password is stored and the user is notified 404 how to change the password in the future and the process goes to ZingBack 107. If the user does not want the system to remember the password, the user is notified 403 that it will be necessary to reenter the password each time and the process goes to ZingBack 107.

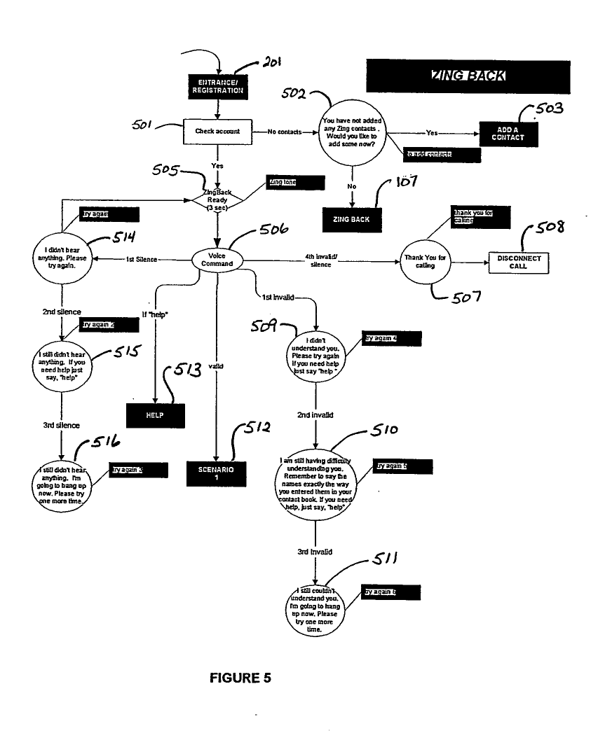

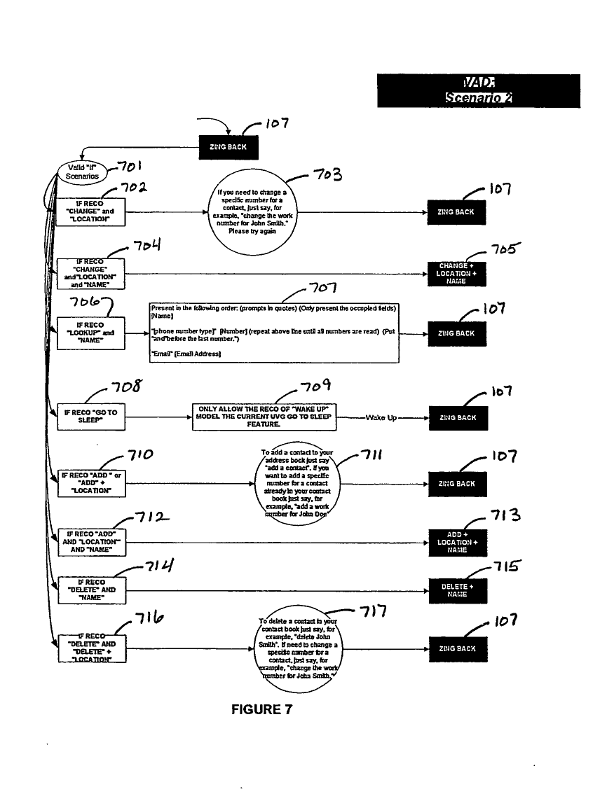

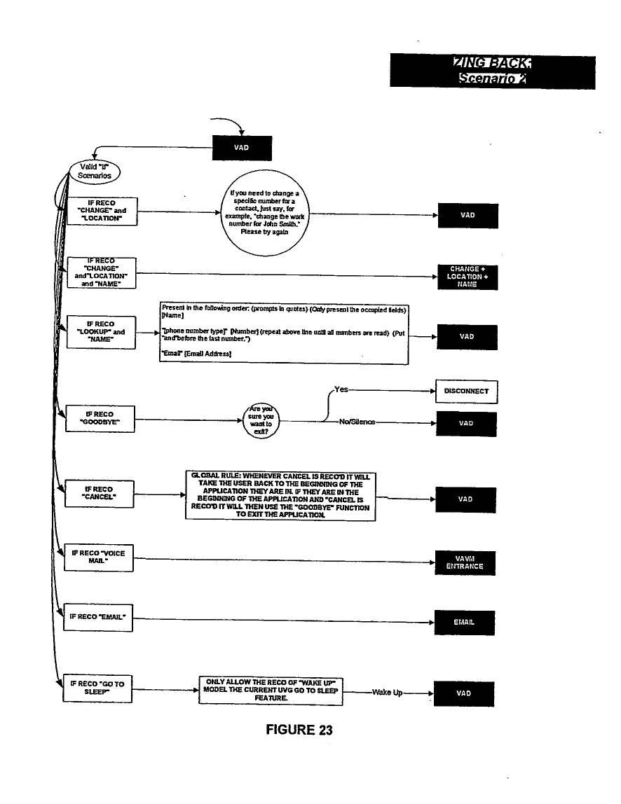

FIG. 5 shows a detailed flow chart of the ZingBack 107 section. From the Entrance or Registration section 201, the user's account is checked 501. If no contacts are stored, the user is informed 502 that no contacts have been entered and the user is asked if they would like to enter a contact If so, the process goes to the Add a Contact section 503, if not the process goes to back to ZingBack 107. If the account has contacts then a test 505 is made to determine if ZingBack is ready. If so, a voice command is received 506. If the voice command received is not understandable; the first time, a request 509 is made to try again; the second time, an second request to try again is made 510; the third time a failure message is give 511 and the system gives one more chance. After the fourth failure, the system thanks 507 the user and disconnects 508 the call. If the voice command is understood, the process goes to Scenario 1 512. (In alternative embodiments the process may go to Scenario 2 or the alternative Scenario 2, shown in FIGS. 7 and 23 respectively). If a request for help is received, the process goes to the Help section 513. If silence is received, the first time the user is prompted 514 to try again; the second time the user is prompted 515 to try again; the third time the user is told 516 that after one additional try the system will hang-up.

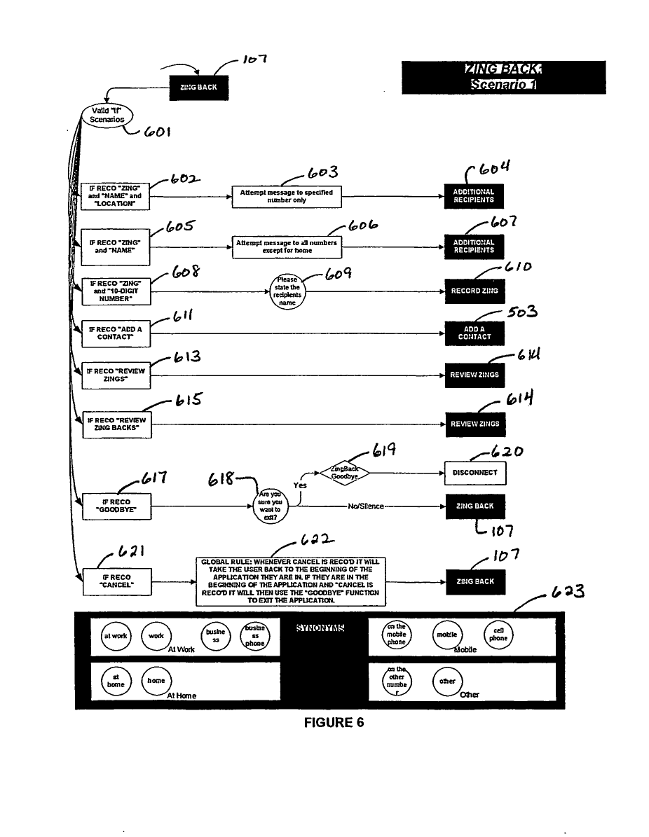

FIG. 6 shows a detailed flow chart of the scenario 1 512 section. From the ZingBack 107 section a test 601 is made for valid scenarios. If 602 Zing, a name and a location are received, then a message is attempted 603 to the specified number only and the process goes to Additional Recipients 604. If 605 Zing and a name are received, an attempt 606 is made to send the message to all associated numbers and the process goes to Additional Recipients 604. If 608 Zing and a 10 digit number are received, then the user is asked 609 to state the recipient's name and the process goes to the Record Zing 610 section. If 611 add a contact is received, then the process goes to the Add a Contact 503 section. If 613 review Zings is received, the process goes to the Review Zings 614 section. If 615 review Zings back is received, the process goes to the Review Zings 614. If 617 goodbye is received, the user is asked 618 if they want to exit, if so 619, the system disconnects 620. If not or silence, the process returns to ZingBack 107. If 621 cancel is received, the user is taken back to the beginning 622 and returned to ZingBack 107. The process provides the capability of applying synonyms 623 for shortcuts in the verbal process.

FIG. 7 is a detailed flow chart of the optional scenario 2 section. From the ZingBack 107 section a test 701 is made for valid scenarios. If 702 change and location are received, then the user is informed 703 how to change a number for a contact the process goes to ZingBack 107. If 704 change, location and a name are received, the process goes to change+location+name 705. If 706 lookup and name are received, then the user is asked 707 to state specific information and the process goes to the ZingBack 107 section. If 709 go to sleep is received, then the process goes to sleep 709 until receiving a “Wake Up”. After the “Wake Up” the process returns to ZingBack 107. If 710 receives an add or add plus location, the user is told 711 how to add contacts and is sent to ZingBack 107. If 712 add and location and name are received, the process goes to the Add+Location+Name 713 section. If 714 delete and name are received, the process goes to the Delete+Name 715 section. If 716 delete and delete+location are received, the user is told 717 how to delete a contact and the process goes to ZingBack 107.

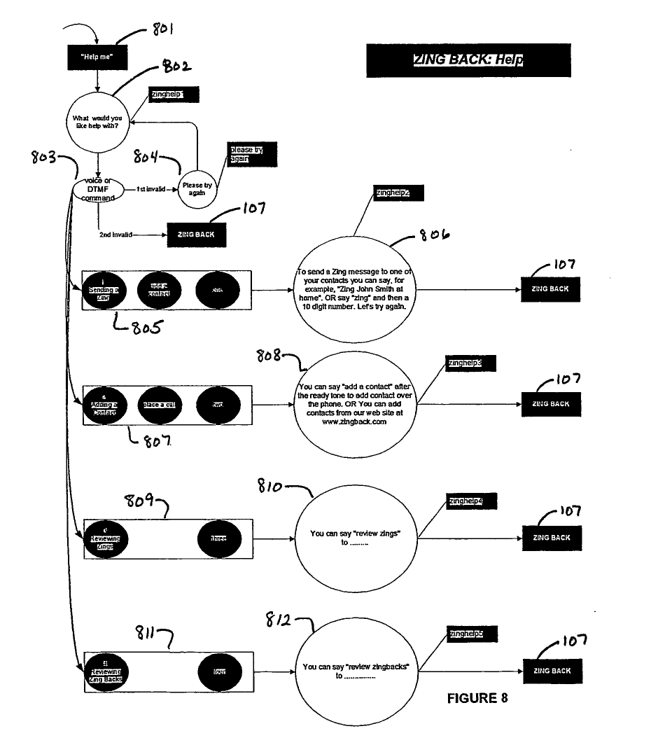

FIG. 8 shows a detailed flow chart of the help 513 section. A help request 801 is received. The user is queried 802 about that type of help requested. The user's response is received 803. If the response is invalid, the first time the user is prompted 804 to try again, the second time the process returns to ZingBack 107. If the response is valid, and it concerns a Zing 805, the user is informed 806 how to send a Zing and the process returns to ZingBack 107. If the response concerns adding a contact 807, the user is informed 808 how to add a contact and the process returns to ZingBack 107. If the response concerns reviewing a Zing 809, the user is informed 810 how to review a Zing and the process returns to ZingBack 107. If the response concerns reviewing a Zing Back 811, the user is informed 812 how to review a Zing Back and the process returns to ZingBack 107.

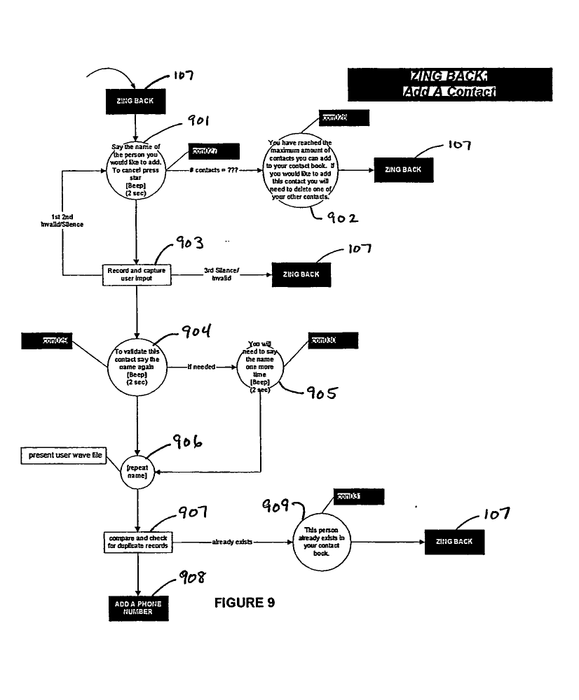

FIG. 9 is a detailed flow chart of the add a contact 503 section. From the ZingBack 107 section the user is asked 901 the name of the person to be added. If the maximum number of contacts has been reached, a message is sent 902 informing the user of such, and the process returns to ZingBack 107. If the maximum number of contacts has not been reached, the user input is recorded 903. If the user input is invalid or silence, the first and second times, the user is again prompted 901 for the name of the person to be added. The third time, the process returns to ZingBack 107. Valid information is validated 904, if necessary the user is asked 905 to say the name one more time. If not necessary, the name is repeated 906 and the name is compared and checked 907 for duplicate records. If the name is a duplicate, a message is sent 909 indicating that the person is already in the contact book and the process returns to ZingBack 107. If the name is not a duplicate, the phone number is added 908.

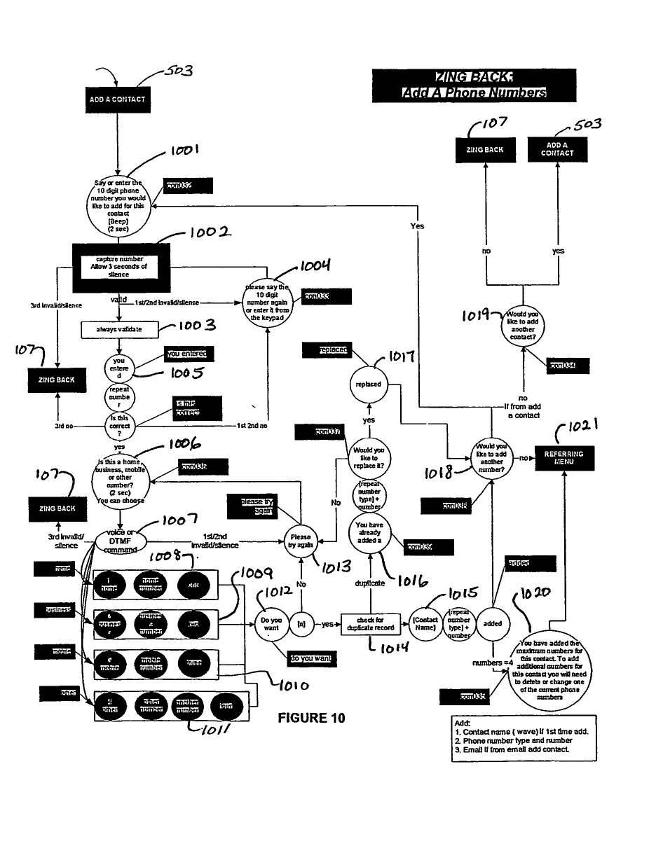

FIG. 10 shows a detailed flow chart of the add a phone number 908 section. From the Add a Contact 503 section, the user is asked 1001 to say the number to be added. The number is captured 1002. If not valid, the first and second times, the user is asked 1004 to try again, the third time, the process returns to ZingBack 107. If valid, the number is validated 1003, by confirming the number 1005. The user is asked 1006 if the number is for a home, business or other. If this response is invalid, the first and second times the user is asked 1013 to try again, the third time, the process returns to ZingBack 107. If the response is a home 1008, a business 1009, a mobile 1010, or other 1011, the user is asked 1012 if they want to store the number. If not, the user is prompted 1013 to try again. If the user wants to store the number, a check 1014 is made for a duplicate record. If it is a duplicate record, the user is told 1016 that it is a duplicate and asked if it should be replaced 1017. If it is not a duplicate record, the contact name is collected 1015. If no additional numbers are added 1018, the user is asked 1019 if they want to add another contact. If yes, the process returns to Add a Contact 503, if not the process goes to ZingBack 107. If the contact name is added, a test 1020 is made to determine if the maximum number has been reached, if not the user is asked 1018 if another number should be added. If so, the user is given the message 1020 that the maximum has been reached and the process goes to the referring menu 1021.

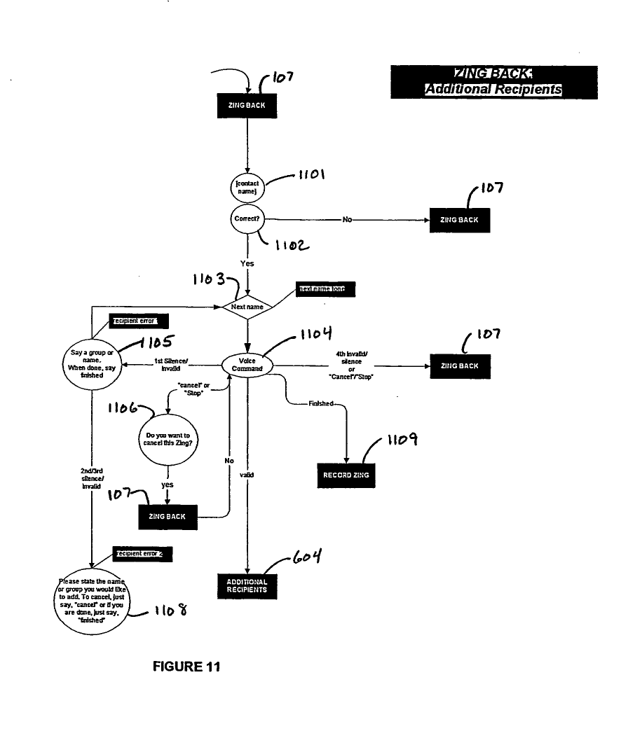

FIG. 11 shows a detailed flow chart of the additional recipients 604 section. From ZingBack 107, the contact name is received 1101. A test 1102 is made to determine if it is correct. If not, the process returns to ZingBack 107. If it is, a test 1103 is made to determine if it is the next name. A command is received 1104. If the command is invalid, the first through third times the user is asked 1105 to try again and again 1108, if the fourth time, the process returns to ZingBack 107. If the command is that the user is finished then the process goes to Record Zing 1109. If the command is valid, the process goes to Additional Recipients 604.

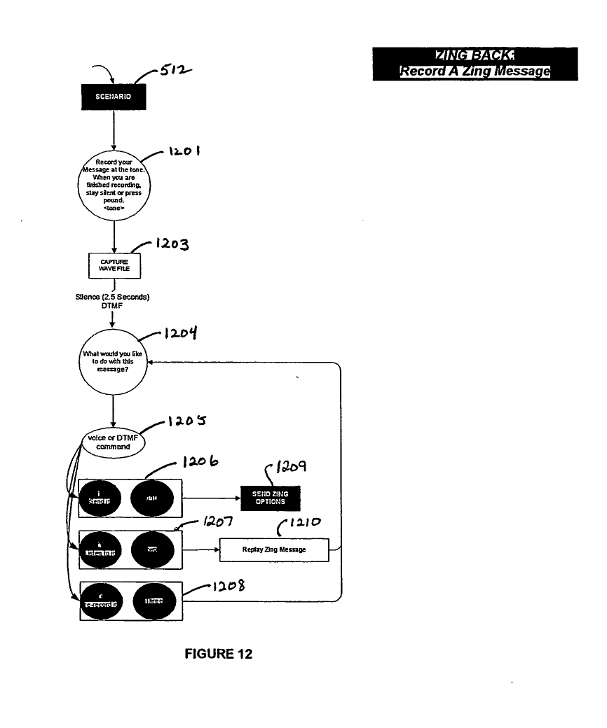

FIG. 12 shows a detailed flow chart of the record a zing message 1301 section. From a scenario 512, an instruction 1201 is made to record the message. The wave file is captured 1203. An inquiry 1204 is made to determine what the user wants to do with this message. A command 1205 is received. The command can be send it 1206, listen to it 1207 or re-record it 1208. If the command is send it 1206 the Zing Options are sent 1209. If the command is listen to it 1207, replay 1210 the Zing message.

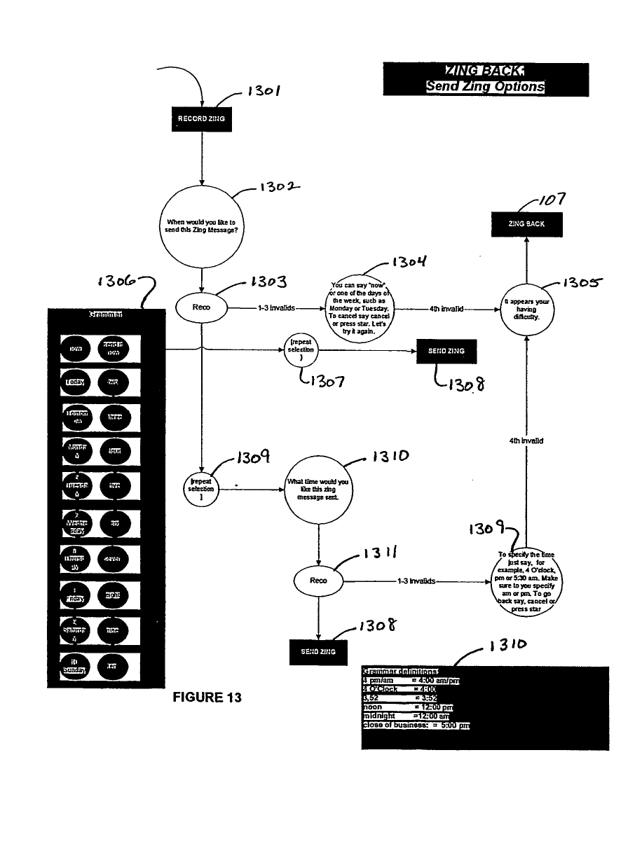

FIG. 13 shows a detailed flow chart of the send a zing options 1308 section. From record Zing 1301, an inquiry 1302 is made about when the message should be sent. A response 1303 is received. If it is invalid one to three times, an instruction 1304 is made to try again. The fourth time it is invalid a difficulty response 1305 is given and the process returns to ZingBack 107. If the response is valid, the selection is repeated, 1307, 1309, If the response came from the grammar 1306, after repeating the selection 1307, the Zing is sent 1308. After the 1309 repeat, the user is asked 1310 when the message should be sent A response is received 1311. If valid, the Zing is sent 1308. If the response is invalid, one to three times, the user is asked 1309 to say the time. Grammar definitions 1301 are also provided.

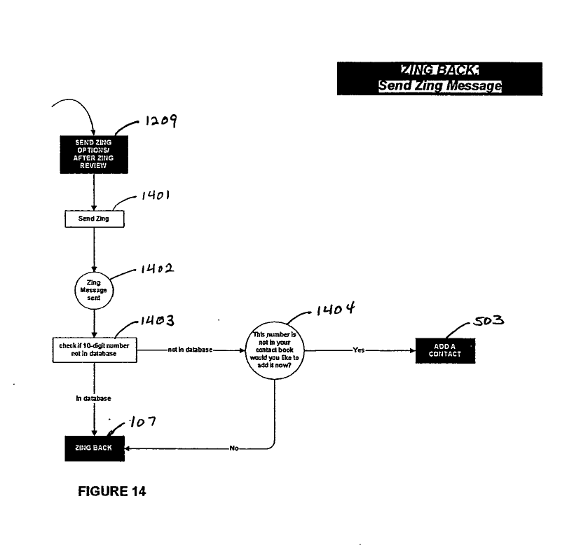

FIG. 14 shows a detailed flow chart of the send a zing message section. From the Send Zing Options 1209, the Zing is sent 1401. Confirmation 1402 of the sent Zing is made. A check 1403 is made to determine if the 10 digit number is not in the database. If not in the database, a message 1404 is sent to add it now. If Yes, the process goes to Add a Contact 503. If not, to ZingBack 107.

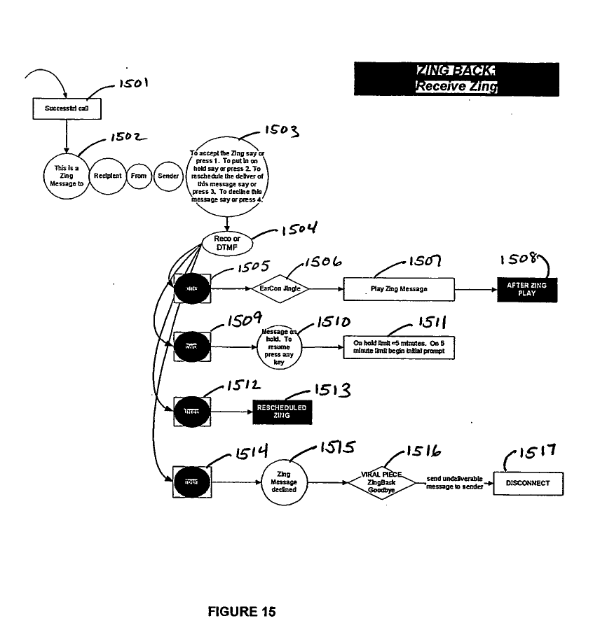

FIG. 15 shows a detailed flow chart of the receive a zing section. A successful call 1501 is made. The message 1502 is sent that is a Zing and the recipient is asked 1503 to accept the message. A command 1504 is received. If one 1505, the earcon is jingled 1506 and the Zing message is played 1507 and the process goes to After Zing Play 1508. If two 1509 is received, a message on hold 1510 is made and the process is held 1511. If three 1512, the Zing is rescheduled 1513. If four 1514, the message is declined 1515, and the viral piece 1516 sends a goodbye and disconnects 1517.

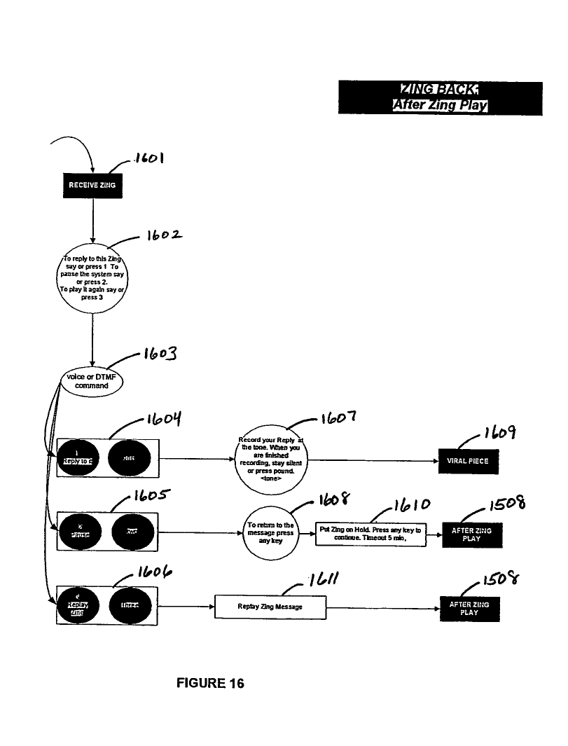

FIG. 16 shows a detailed flow chart of the after zing play 1508 section. From a received Zing 1601, an instruction 1602 is given as to how to respond. A command is received 1603. If the command is to reply 1604, the instruction 1607 of how to reply is given and the Viral Piece 1609 section is entered. If the command is to pause 1605, an instruction 1608 as to how to return to the message is given and the Zing is put on hold 1610 and the process goes to After Zing Play 1508. If the command is to replay Zing 1606, the Zing message is replayed 1611, and the process goes to After Zing Play 1508.

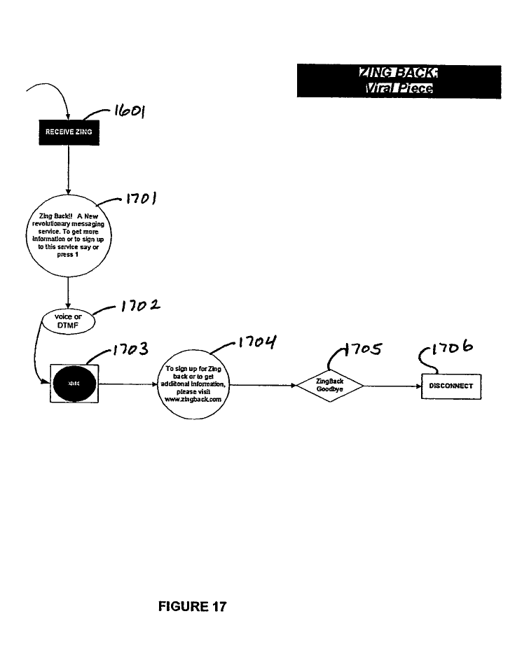

FIG. 17 shows a detailed flow chart of the viral piece 1609 section. From the Receive Zing 1601, a message is delivered 1701, a command 1702 is received. The command is a one 1703, and the recipient is asked 1704 about signing up for this process. A ZingBack goodbye 1705 is sent and the line is disconneced 1706.

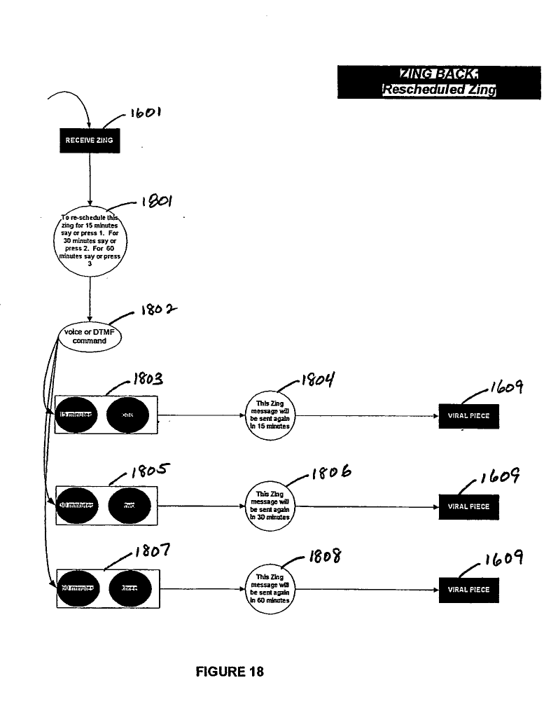

FIG. 18 shows a detailed flow chart of the rescheduled zing section. From the Receive Zing 1601, a message is sent 1801 regarding rescheduling. A command is received 1802. If 15 minutes is selected 1803, the Zing message is sent in 15 minutes and the process goes to Viral Piece 1609. If 30 minutes is selected 1805, the Zing message is sent in 30 minutes and the process goes to Viral Piece 1609. If 60 minutes is selected 1807, the Zing message is sent in 60 minutes and the process goes to Viral Piece 1609.

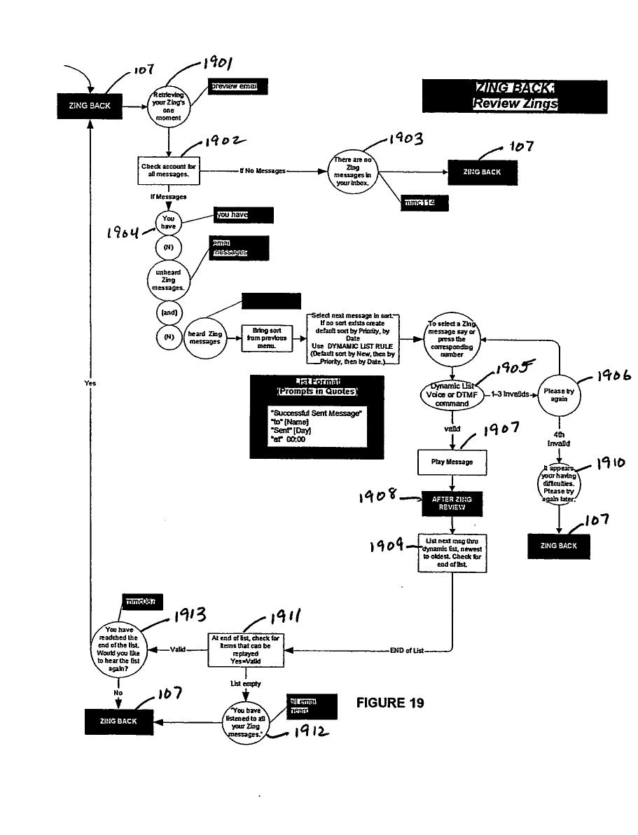

FIG. 19 shows a detailed flow chart of the review zings section. From the ZingBack 107. A message 1901 is sent to retrieve the Zing. The account is checked 1902. If no messages, then a no message message 1903 is sent and the process goes to ZingBack 107. If there are messages, a message 1904 is sent, the dynamic list command is received 1905, if invalid, the user is instructed to try again 1906, and eventually 1910 sent back to ZingBack 107. If valid, the message is played 1907. After Zing review 1908 the next message is listed 1909. At the end of the list, items for replay are checked 1911, if empty 1912 a message is sent, if valid, a valid message is sent 1913. If the user wants to hear more, it goes to ZingBack 107, if not it goes to ZingBack 107.

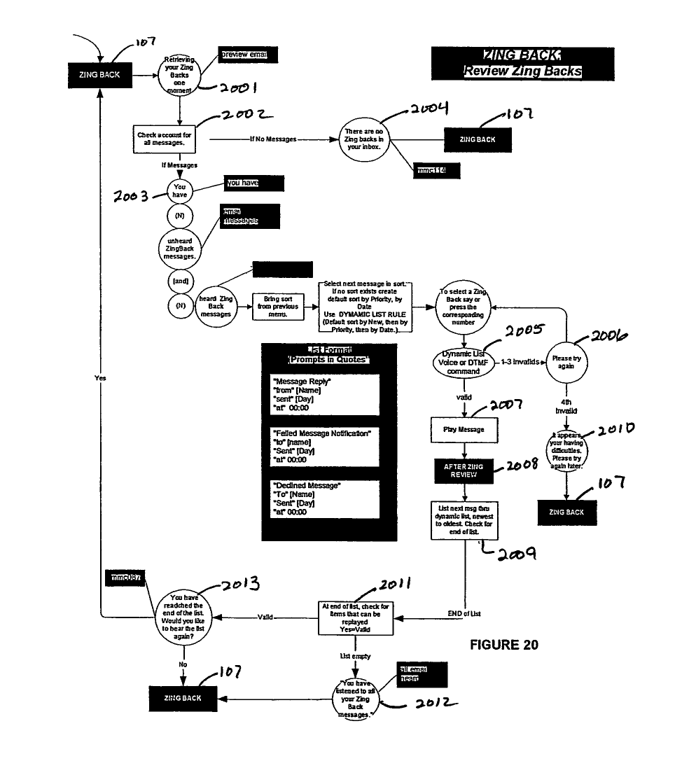

FIG. 20 shows a detailed flow chart of the review zing backs section. A message 2001 is sent to retrieve the Zing. The account is checked 2002. If no messages, then a no message message 2004 is sent and the process goes to ZingBack 107. If there are messages, a message 2003 is sent, the dynamic list command is received 2005, if invalid, the user is instructed to try again 2006, and eventually 2010 sent back to ZingBack 107. If valid, the message is played 2007. After Zing review 2008 the next message is listed 2009. At the end of the list, items for replay are checked 2011, if empty 2012 a message is sent, if valid, a valid message is sent 2013. If the user wants to hear more, it goes to ZingBack 107, if not it goes to ZingBack 107.

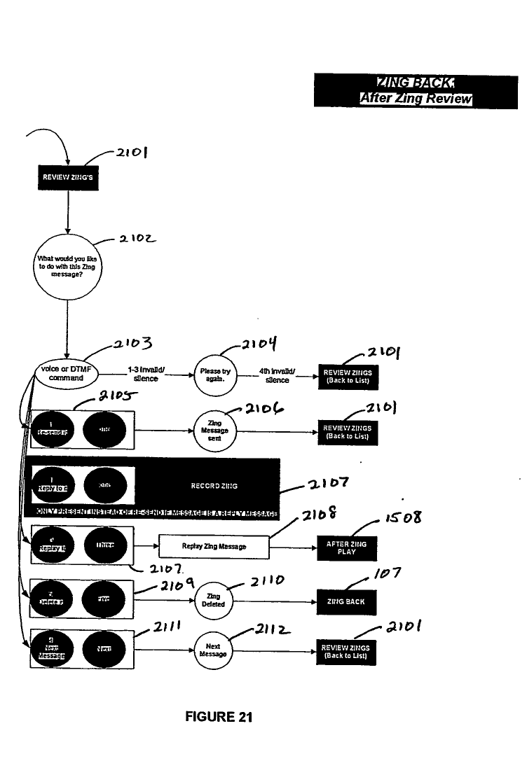

FIG. 21 shows a detailed flow chart of the after zing review section. From the Review Zing 2101, a message is sent 2102 regarding what to do with the message. A command is received 2103. If invalid, the user is instructed 2104 to try again, and eventually returning to Review Zing 2101. If re-sent is selected 2103, the Zing message is sent 2106 and the process goes to Review Zings 2101. If reply is selected 2107, the Zing message is replied to. If replay is selected 2107, the Zing message is replayed 2108 and the process goes to After Zing Play 1508. If delete it is selected 2109, the Zing is delivered 2110, and the process goes to ZingBack 107. If next message is selected 2111, the next message 2112 is retrieved and the Zing is Reviewed 2101.

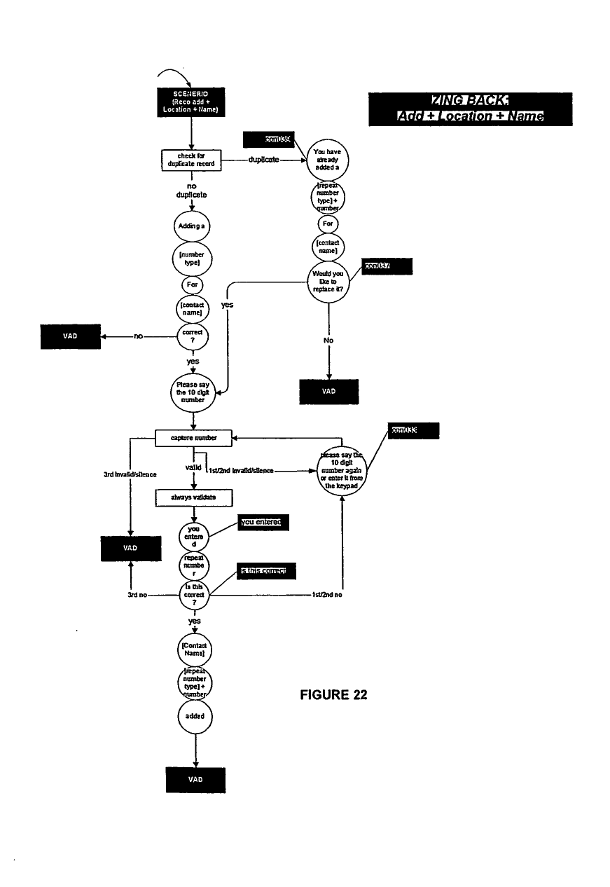

FIG. 22 shows a detailed flow chart of the add+location+name section. The detail of this chart is self evident.

FIG. 23 shows a detailed flow chart of the alternative scenario 2 section. The detail of this chart is self evident.

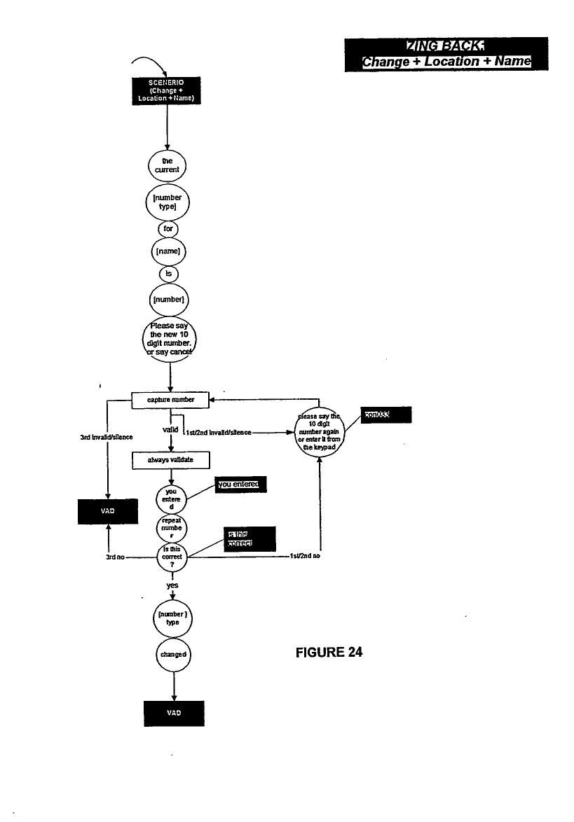

FIG. 24 shows a detailed flow chart of the change+location+name section. The detail of this chart is self evident.

It is to be understood that the above described and referenced embodiments and examples are merely illustrative of numerous and varied other embodiments and applications which may constitute applications of the principles of the invention. These example embodiments are not intended to be exhaustive or to limit the invention to the precise form, connection or choice of components, process steps or order of steps, disclosed herein as the present preferred embodiments. Obvious modifications or variations are possible and foreseeable in light of the above teachings. These embodiments of the invention were chosen and described to provide the best illustration of the principles of the invention and its practical application and to thereby enable one of ordinary skill in the art to make and use the invention, without undue experimentation. Other embodiments may be readily devised by those skilled in the art without departing from the spirit or scope of this invention and it is our intent that they be deemed to be within the scope of this invention, as determined by the appended claims, when they are interpreted in accordance with the breadth to which they are fairly, legally and equitably entitled.

1. A method for sending an automatic telephone message, comprising:
(A) entering a message;
(B) identifying a recipient;
(C) specifying a time for delivery of said message;
(D) placing an automatic call at about said specified time for delivery;
(E) announcing said automatic call to said recipient;
(F) recording said recipient's response; and
(G) storing said message and said response.

2. A method as recited in claim 1, further comprising:
(H) sending said recipient's response.

3. A method as recited in claim 1, further comprising:
(I) reviewing said message.

4. A method as recited in claim 1, further comprising:
(J) prompting said recipient to provide a response.
